(19) United States
(12) Patent Application Publication
(10) Pub. No.: US 2011/0222858 A1
(43) Pub. Date: Sep. 15, 2011

(54) OPTICAL COMMUNICATION APPARATUS AND OPTICAL COMMUNICATION METHOD

(75) Inventors: Hidenori TAKAHASHI, Saitama (JP); Itsuro MORITA, Saitama (JP)

(73) Assignee: KDDI R&D LABORATORIES INC., Fujimino-shi (JP)

(21) Appl. No.: 13/011,400

(22) Filed: Jan. 21, 2011

(30) Foreign Application Priority Data
Mar. 9, 2010 (JP) 2010-51590

(51) Int. Cl. H04J 14/00; H04J 14/02

(52) U.S. Cl. 398/79; 398/43

(57) ABSTRACT

A present invention provides an optical communication apparatus and method which can use a data modulator and an OFDM modulator more narrow band than a transmission band.

The optical communication apparatus comprise an intensity modulation means for modulating intensity of continuous light with a sine wave, a means for separating optical signal outputted by said intensity modulation means into a bottom sideband and an upper sideband and outputting, a first modulation means for modulating said upper sideband with a first electrical signal, a second modulation means for modulating said bottom sideband with a second electrical signal, and a multiplex means for multiplexing an output signal from said first modulation means and an output signal from said second modulation means and outputting.

### PRIORITY CLAIM

This application claims priority from Japanese patent application No. 2010-051590, filed on Mar. 9, 2010, which is incorporated herein by reference.

### BACKGROUND OF THE INVENTION

### 1. Field of the Invention

The present invention relates to broadband optical communication. More specifically, the present invention relates to an optical communication apparatus and method suitable for the use of the orthogonal frequency division multiplex (OFDM) modulation.

2. Description of the Related Art

The OFDM modulation is a method to transmit transmission data using a plurality of sub-carriers in parallel, and is strong against an interference between the symbol, because a symbol rate of each sub-carrier becomes relatively low. The OFDM modulation is already used in digital terrestrial broadcast and a wireless LAN (Local Area Network) system, and is examined the application to an optical communication system.

For example, the interleaves whose frequency spacing is 25 GHz, which is described on http://www.optoplex.com/download/Optical_Interleaver.pdf, can make the band of each channel up to 25 GHz. However, to generate an optical OFDM signal of the bandwidth of 25 GHz, the OFDM modulator which performs OFDM modulation in a band of 12.5 GHz or the optical modulator having a band of 12.5 GHz is necessary, it increases cost.

### BRIEF SUMMARY OF THE INVENTION

Therefore, it is an object of a present invention to provide an optical communication apparatus and method which can use a data modulator such as an optical modulator and an OFDM modulator more narrow band than a transmission band.

To realize the above object, according to an optical communication apparatus of the present invention, an optical communication apparatus comprises an intensity modulation means for modulating intensity of continuous light with a sine wave; a means for separating optical signal outputted by said intensity modulation means into a bottom sideband and an upper sideband and outputting; a first modulation means for modulating said upper sideband with a first electrical signal; a second modulation means for modulating said bottom sideband with a second electrical signal; and a multiplex means for multiplexing an output signal from said first modulation means and an output signal from said second modulation means and outputting.

Further, it is also preferable that said apparatus comprises a means for generating continuous light and a branch means for branching off said continuous light and outputting to said intensity modulation means and a third modulation means, and said third modulation means modulates the continuous light from said branch means with a third electrical signal and outputs to said multiplex means.

Further, it is also preferable that total of frequency bands of said first electrical signal and said second electrical signal is equal to or less than twice of a frequency of said sine wave.

Further, it is also preferable that total of frequency bands of said first electrical signal and said third electrical signal and total of frequency bands of said second electrical signal and said third electrical signal are equal to or less than a frequency of said sine wave.

Further, it is also preferable that said first electrical signal, said second electrical signal and said third electrical signal are signals modulated by an orthogonal frequency division multiplex.

To realize the above object, according to an optical communication method comprise a step of modulating intensity of continuous light with a sine wave; a step of separating optical light modulated the intensity into a bottom sideband and an upper sideband and outputting; a step of modulating said upper sideband with a first electrical signal; a step of modulating said bottom sideband with a second electrical signal; and a step of multiplexing an output signal modulated by said first electrical signal and an output signal modulated by said second electrical signal and outputting.

To realize the above object, according to an optical communication method comprising: a step of generating continuous light; a step of branching off said continuous light into a first continuous light and a second continuous light; a step of modulating intensity of said first continuous light with a sine wave; a step of separating optical light modulated the intensity into a bottom sideband and an upper sideband and outputting; a step of modulating said upper sideband with a first electrical signal; a step of modulating said bottom sideband with a second electrical signal; a step of modulating said second continuous light with a third electrical signal; and a step of multiplexing an output signal modulated by said first electrical signal, an output signal modulated by said second electrical signal and an output signal modulated by said third electrical signal and outputting.

According to the present invention, the optical communication apparatus and the method can use the data modulator such as the optical modulator or the OFDM modulator more narrow band than the transmission band.

### BRIEF DESCRIPTION OF THE SEVERAL VIEWS OF THE DRAWINGS

FIG. 1 shows a schematic configuration of the optical OFDM communication apparatus according to the present invention;

FIGS. 2a to 2d show a schematic optical spectrum in each part of the optical OFDM communication apparatus according to the present invention; and

FIGS. 3a to 3d show a schematic optical spectrum in each part of the optical OFDM communication apparatus according to the present invention.

### DETAILED DESCRIPTION OF THE INVENTION

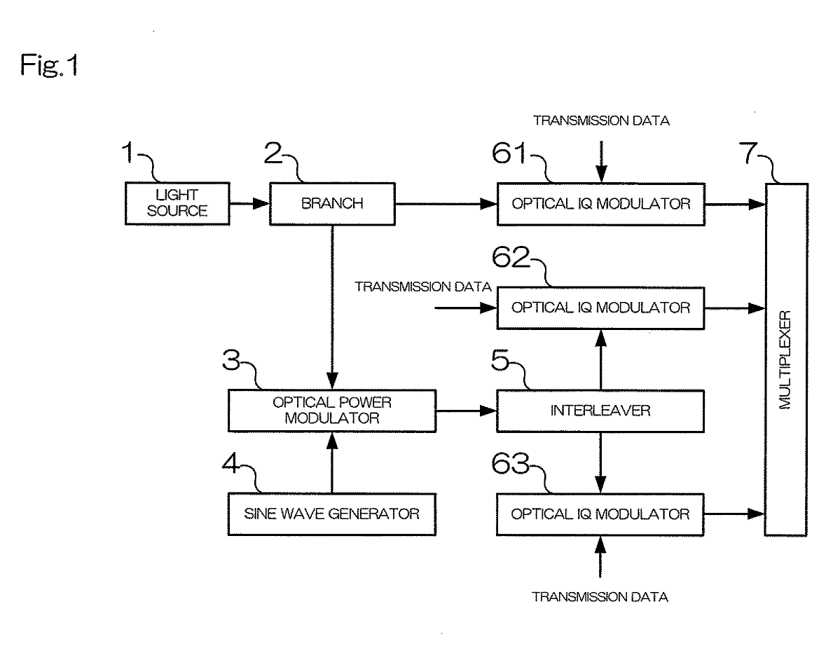

An embodiment of the present invention will be described below with reference to the drawings in detail. Note that, the following description describes an optical OFDM communication apparatus, however the present invention can be applicable to an optical communication apparatus using modulation but the OFDM modulation. FIG. 1 shows a schematic configuration of the optical OFDM communication apparatus according to the present invention. As shown in FIG. 1, the optical OFDM communication apparatus comprises a light source 1, a branch 2, an optical power modulator 3, a sine wave generator 4, an interleaver 5, optical IQ modulators 61, 62 and 63, and a multiplexer 7.

The light source 1 generates continuous light of frequency f₀, the branch 2 branches off the continuous light into two, each is outputted to the optical IQ modulator 61 and the optical power modulator 3. The optical power modulator 3 modulates intensity of continuous light of frequency f₀ with a sine wave of frequency f₁ generated by the sine wave generator 4, further, the optical power modulator 3 suppresses a carrier wave and outputs the suppressed carrier wave. The interleaver 5 separates the optical signal which the optical power modulator 3 outputs into the bottom sideband (frequency f₀−f₁) and the upper sideband (frequency f₀+f₁), and outputs each to the optical IQ modulators 62 and 63.

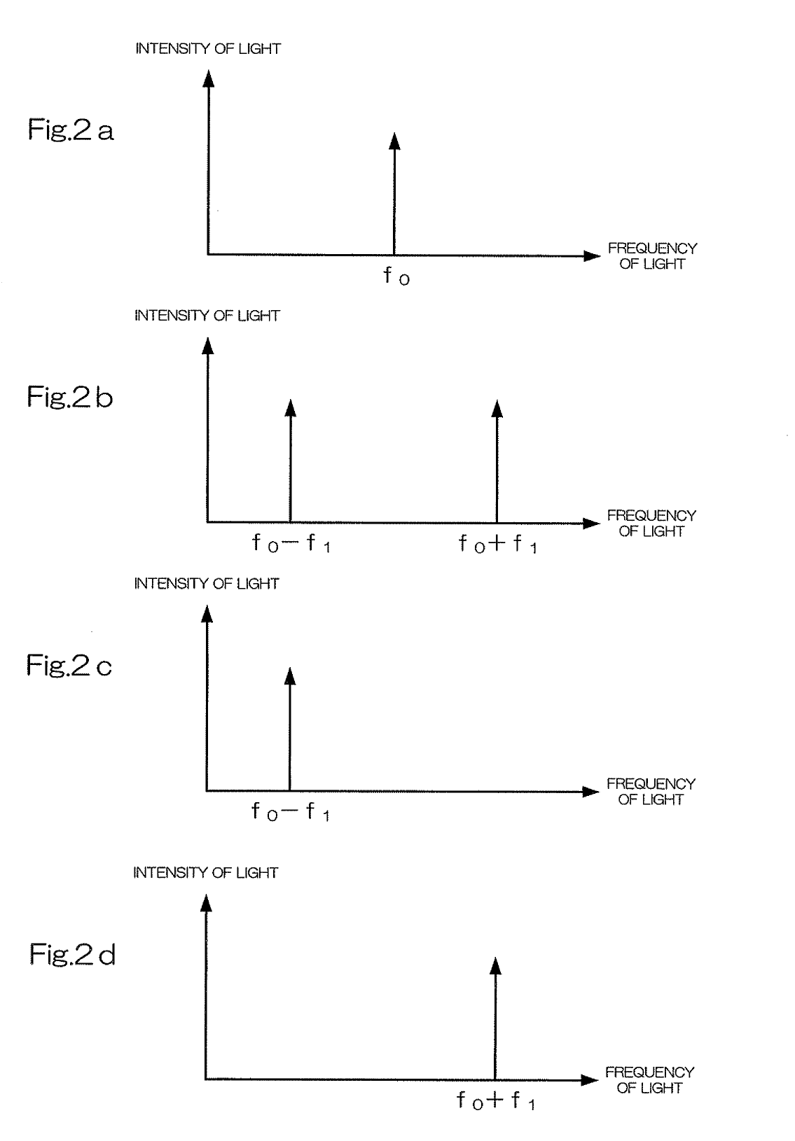

FIG. 2a shows an optical spectrum of the optical signal which the light source 1 outputs, FIG. 2b shows an optical spectrum of the optical signal which the optical power modulator 3 outputs, FIG. 2c shows an optical spectrum of the optical signal which the interleaver 5 outputs to the optical IQ modulator 62, and FIG. 2d shows an optical spectrum of the optical signal which the interleaver 5 outputs to the optical IQ modulator 63, respectively.

In the optical IQ modulators 61, 62, and 63, OFDM base band signal (in-phase and orthogonal components) is inputted from an OFDM modulator (not shown). The optical IQ modulators 61, 62, and 63 modulate the inputted continuous light with the OFDM base band signal and output to the multiplexer 7, respectively. The multiplexer 7 multiplexes the optical signals outputted from the optical IQ modulators 61, 62, and 63 and outputs. Note that the maximum frequency of the OFDM base band signal inputted to the optical IQ modulators 61, 62, and 63 is fₐ, f_{b}, and f_{c}, respectively, and fₐ+f_{b} and fₐ+f_{c} are equal to or less than f₁.

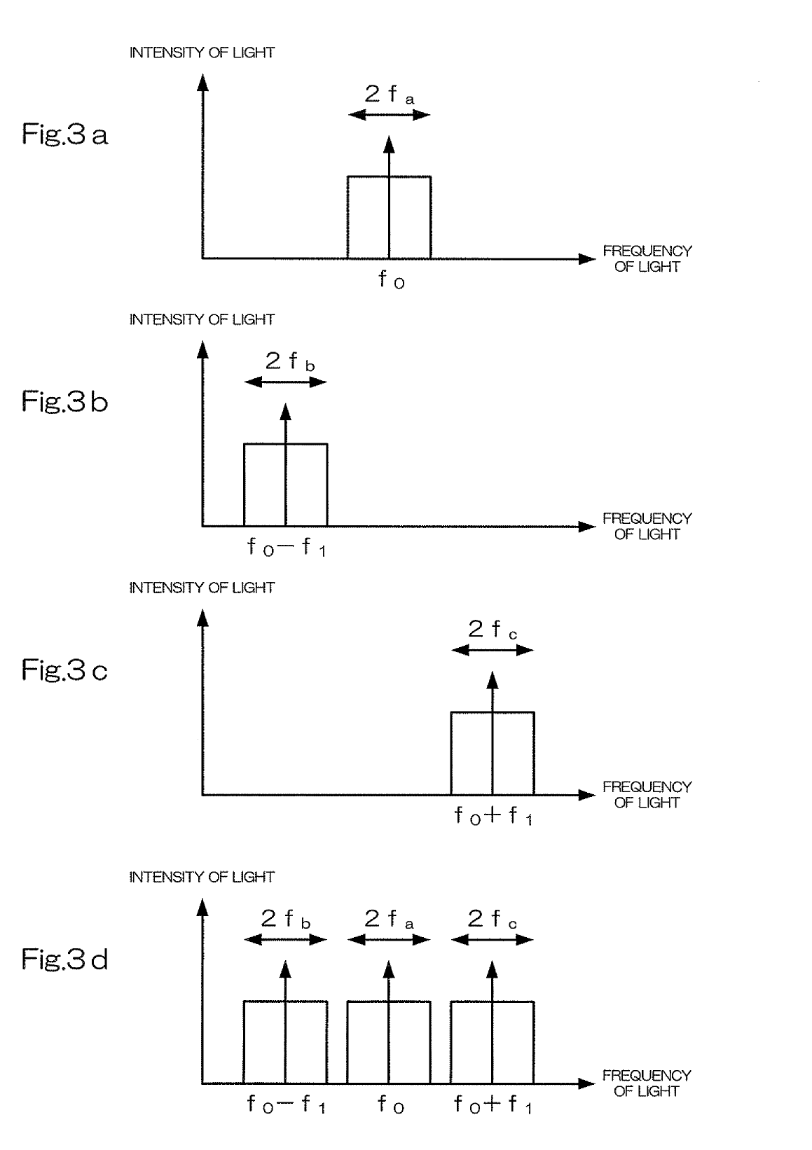

FIG. 3a shows an optical spectrum of the optical signal which the optical IQ modulator 61 outputs, FIG. 3b shows an optical spectrum of the optical signal which the optical IQ modulator 62 outputs, FIG. 3c shows an optical spectrum of the optical signal which the optical IQ modulator 63 outputs, and FIG. 2d shows an optical spectrum of the optical signal which the multiplexer 7 outputs, respectively. As is apparent from FIG. 3, in the present invention, for example, if the bands of the OFDM base band signal to input to the optical IQ modulators 61, 62, and 63 are same, the band which is necessary for the optical IQ modulators 61, 62, and 63 or the OFDM modulator generating the OFDM base band signal becomes one-third in comparison with the prior art. Therefore, the demand condition about the band which is necessary for each component becomes loose, then it is possible to generate the broadband OFDM signal at low cost.

Note that in the above embodiment, the embodiment uses three optical IQ modulators. However, it is possible that the embodiment uses two optical IQ modulators. Specifically, it is possible that the branch 2 and the optical IQ modulator 61 in FIG. 1 are not used and the continuous light from the light source 1 is directly inputted to the optical power modulator 3. In this case, f_{b}+f_{c} is equal to or less than 2f₁.

1. An optical communication apparatus comprising:
an intensity modulation means for modulating intensity of continuous light with a sine wave;
a means for separating optical signal outputted by said intensity modulation means into a bottom sideband and an upper sideband and outputting;
a first modulation means for modulating said upper sideband with a first electrical signal;
a second modulation means for modulating said bottom sideband with a second electrical signal; and
a multiplex means for multiplexing an output signal from said first modulation means and an output signal from said second modulation means and outputting.

2. The optical communication apparatus according to claim 1, wherein said apparatus comprises
a means for generating continuous light and
a branch means for branching off said continuous light and outputting to said intensity modulation means and a third modulation means, and
said third modulation means modulates the continuous light from said branch means with a third electrical signal and outputs to said multiplex means.

3. The optical communication apparatus according to claim 1, wherein total of frequency bands of said first electrical signal and said second electrical signal is equal to or less than twice of a frequency of said sine wave.

4. The optical communication apparatus according to claim 2, wherein total of frequency bands of said first electrical signal and said third electrical signal and total of frequency bands of said second electrical signal and said third electrical signal are equal to or less than a frequency of said sine wave.

5. The optical communication apparatus according to claim 2, wherein said first electrical signal, said second electrical signal and said third electrical signal are signals modulated by an orthogonal frequency division multiplex.

6. An optical communication method comprising:
a step of modulating intensity of continuous light with a sine wave;
a step of separating optical light modulated the intensity into a bottom sideband and an upper sideband and outputting;
a step of modulating said upper sideband with a first electrical signal;
a step of modulating said bottom sideband with a second electrical signal; and
a step of multiplexing an output signal modulated by said first electrical signal and an output signal modulated by said second electrical signal and outputting.

7. An optical communication method comprising:
a step of generating continuous light;
a step of branching off said continuous light into a first continuous light and a second continuous light;
a step of modulating intensity of said first continuous light with a sine wave;
a step of separating optical light modulated the intensity into a bottom sideband and an upper sideband and outputting;
a step of modulating said upper sideband with a first electrical signal;
a step of modulating said bottom sideband with a second electrical signal;
a step of modulating said second continuous light with a third electrical signal; and
a step of multiplexing an output signal modulated by said first electrical signal, an output signal modulated by said second electrical signal and an output signal modulated by said third electrical signal and outputting.
